(19) United States
(12) Patent Application Publication
(10) Pub. No.: US 2010/0067524 A1
(43) Pub. Date: Mar. 18, 2010

(54) Method and system for selecting a data transmission rate

(76) Inventor: Vinod Luthra, Zoetermeer (NL)

Correspondence Address: MICHAELSON & ASSOCIATES, P.O. BOX 8489, RED BANK, NJ, 07701-8489, US

(21) Appl. No.: 12/311,394

(22) PCT Filed: Sep. 21, 2007
(86) PCT No.: PCT/EP2007/008221

§ 371 Date: Mar. 27, 2009

Related U.S. Application Data
(60) Provisional application No. 60/848,255, filed on Sep. 28, 2006.

(51) Int. Cl. H04L 12/56

(52) U.S. Cl. 370/389

(57) ABSTRACT

A method and system for selecting a data transmission rate in a broadband network. The broadband network is connected to an access network for providing access for user equipment to the broadband network. Rate information is received from the user equipment. The rate information comprises a rate for transmitting data over the access network. Thereafter, a rate for transmitting data over the broadband network is selected. The selected rate for the broadband network is preferably less than or substantially equal to the rate for transmitting data over the access network.

### FIELD OF THE INVENTION

The invention relates to a method and system for selecting a data transmission rate, and specifically selecting a data transmission rate for data transmission over a broadband network.

### BACKGROUND OF THE INVENTION

Broadband subscriber services can be offered using Digital Subscriber Line (DSL) technology. DSL technology, such as ADSL, SDSL and VDSL, uses a telephony line in a local loop (i.e., copper lines, which support an access network) to connect a subscriber to a broadband network. Copper lines in the local loop suffer from electromagnetic interference that, e.g., reduces the signal-to-noise ratio of a copper line. DSL technology is designed to cope with this type of interference.

The rate at which data can be transmitted (also referred to as “line rate”) may vary based on actual line conditions at a particular point in time. The line rate depends, e.g., on line conditions at start-up of a connection. During synchronization of DSL modems, an appropriate line rate will be established. The actual line rate can, however, decrease or increase any time during the connection due to such electromagnetic interference.

A subscriber typically has a contract with an Internet Service Provider (ISP) or another party for a particular data transmission rate over the network. In the case of ADSL, the contracted download transmission rate is generally higher than the upload transmission rate. As an example, a subscriber may have a download (or downstream) rate of 4 Mbps and an upload (or upstream) rate of 1 Mbps.

Typically, the local loop access network is connected to a broadband network. Tunnels are provided for data transmission over the broadband network. Each tunnel is allocated to a group of subscribers with the same subscription line rate. As an example, a broadband network (or a part thereof) may have three tunnels: one for a group of subscribers with 2 Mbps/512 kbps, one for a group of subscribers with 4 Mbps/1 Mbps and one for a group of subscriber with 8 Mbps/1.5 Mbps (downstream/upstream).

Since the actual data transmission rate in the access network may vary as a result of electromagnetic interference, a mismatch may occur between the data transmission rate in the access network and the data transmission rate in the (tunnel(s)) of the broadband network. As a consequence, a bottleneck exists between the access network and the broadband network. Today, this bottleneck is mainly present in the downstream direction as the data transmission rate of the access network is (much) lower than for the broadband network.

Attempts have been made for solving this problem using buffers in, e.g., a digital subscriber line access multiplexer (DSLAM) and/or an edge router. However, when the difference in the actual data transmission rate in the access network (the local loop) and the transmission rate of a tunnel is too large, a buffer will flow over and data will be discarded. In such a situation, data packets may have to be re-transmitted which exacerbates the problem. In time-critical applications (i.e., Voice over IP, IP television), problems may arise as a result from the buffering operation as buffering introduces additional delay and jitter to the bit stream which may be beyond the compensation capability of a receiving codec.

### SUMMARY OF THE INVENTION

It is an object of the invention to reduce or eliminate the above-described problem of a mismatch between the data transmission rate in the access network and the data transmission rate in the broadband network.

To that end, a data transmission rate is selected through the present inventive method for transmitting data over at least a part of a broadband network. The broadband network is connected to an access network for providing access for user equipment to the broadband network. Rate information is received from the user equipment. The rate information comprises a rate for transmitting data over the access network. Thereafter, a rate for transmitting data over the broadband network is selected. The selected rate for the broadband network is preferably less than or substantially equal to the rate for transmitting data over the access network.

Further, the present invention also involves a system for selecting a data transmission rate. The system comprises a broadband network comprising a first broadband network device and a second broadband network device. The system further comprises an access network arranged for connecting the user equipment to the broadband network. At least one of the first and second broadband network devices are arranged for receiving rate information from said user equipment. The rate information comprises a rate for transmitting data over the access network. At least one of the first and second broadband network devices are arranged for selecting a rate for transmitting data between the first and second broadband network devices. The selected rate is preferably less than or substantially equal to the rate for transmitting data over the access network.

The present invention also teaches user equipment connectable to an access network which provides access to a broadband network. The user equipment is configured to monitor a data transmission rate for data transmission over the access network and to transmit information concerning the data transmission rate over the access network.

The Applicants have observed that DSL user equipment is capable of adapting the data transmission rate to the actual line rate. Therefore, the user equipment is also capable of monitoring the actual line rate of the access network. Applicants have recognized that this information is useful for the broadband network for selecting the data transmission rate of the broadband network in order to tune the data transmission rates of both networks to avoid or reduce a mismatch. Consequently, it is advantageous to receive the data transmission rate of the access network for a particular user equipment and select the data transmission rate for the broadband network for the user equipment on the basis of and/or in response to that information.

### BRIEF DESCRIPTION OF THE DRAWINGS

FIG. 1 is a schematic representation of a communication system in accordance with an embodiment of the invention; and

FIG. 2 is a schematic representation of a user equipment in accordance with an embodiment of the invention.

### DETAILED DESCRIPTION OF THE DRAWINGS

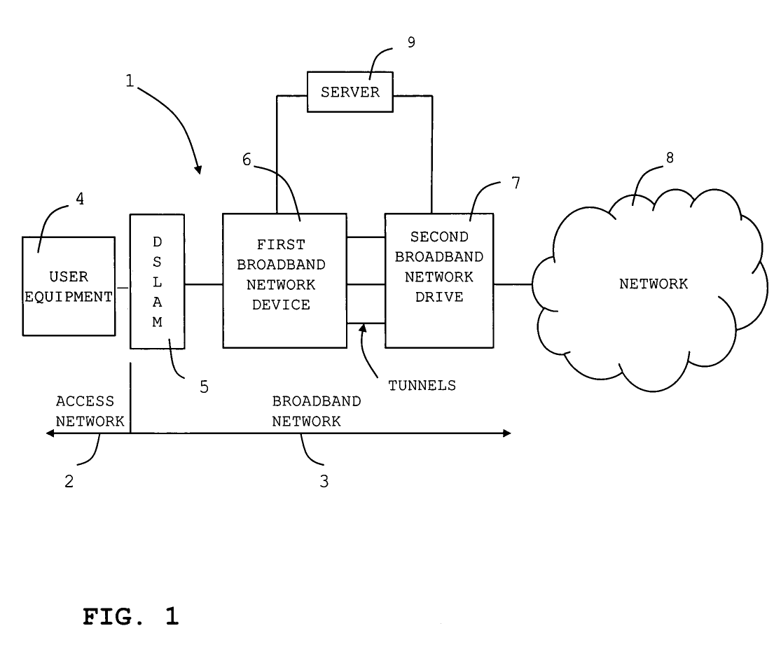

FIG. 1 depicts a schematic illustration of a communication system 1 in accordance with an embodiment of the present invention. The communication system 1 contains an access network 2 and a broadband network 3. The access network 2 (local loop line) may be a telephone line (containing copper wires) and can be either analog or digital (ISDN).

A user equipment 4, such as an ADSL modem, is connected via the access network 2 to a digital subscriber line access multiplexor (DSLAM) 5 providing access to the broadband network 3. The broadband network 3 further comprises a first broadband network device 6, e.g., an edge router, and a second broadband network device 7, e.g., a service provider router (SP router), to communicate with a network 8, such as the internet.

The DSLAM 5 connects an aggregated number of subscribers to the edge router 6 via a fiber connection of, e.g., 155 Mbps. The edge router 6 connects to the SP router 7 that provides access for an Internet Service Provider (ISP) to the internet 8. The broadband network 3 contains the DSLAM 5, the edge router 6 and the SP router 7. A number of (discrete) tunnels (e.g., based on Generic Routing Encapsulation, or GRE) are available for communication between the edge router 6 and the SP router 7. Each tunnel is allocated to a group of subscribers with the same subscription line rate, for example, three tunnels for one group of subscribers with a 2 Mbps/512 Kbps line rate, one group with a 4 Mbps/1 Mbps line rate and one group with a 8 Mbps/1.5 Mbps line rate (downstream/upstream). This allows the ISP and network operator to serve groups of subscribers with different line rates in a different way. Normally, the tunnels are dimensioned in such a way, that an average subscriber will experience the line rate he subscribed to as the actual line rate.

A server 9, such as a remote authentication dial-in user server (RADIUS), is provided for authorization purposes of the user equipment 4. The RADIUS server 9 is arranged for handling subscriber login requests. A login request usually contains the username and the ISP alias. The ISP alias refers to a specific ISP and a subscription line rate. In normal operation, the user equipment 4 sends a point-to-point protocol (PPP) login request to the edge router 6 and the edge router 6 sends the login request to the RADIUS Server 9. The Radius Server then performs an authorization check and, in case of a positive check result, sends an acknowledgement to the edge router 6 and informs the SP router 7 of a successful login by the subscriber. The RADIUS server 9 also informs the SP router 7 of the applicable tunnel.

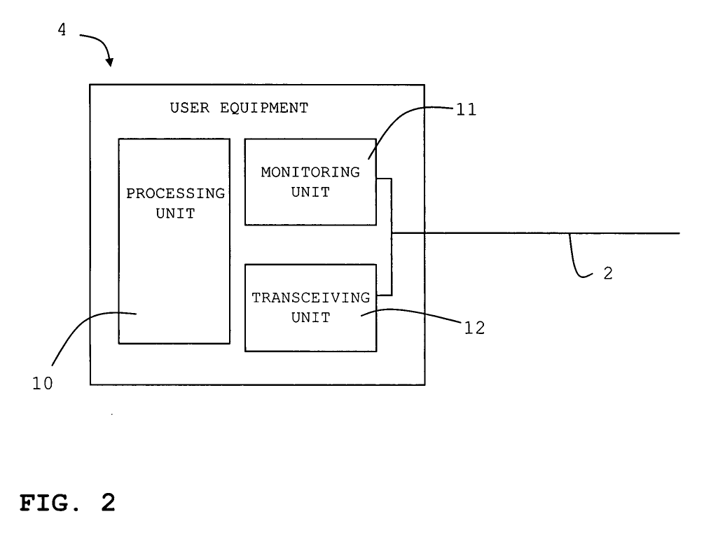

FIG. 2 depicts a schematic illustration of user equipment 4 in accordance with an embodiment of the invention.

The user equipment 4 has a processing unit 10, a monitoring unit 11 and a transceiving unit 12. The processing unit 10 controls the operation of the monitoring unit 11 and the transceiving unit 12. The monitoring unit 11 is capable of monitoring a data transmission rate of the access network 2. The transceiving unit 12 is capable of transmitting information concerning the data transmission rate (the actual line rate) of the access network 2 over the access network 2 to the broadband network 3. It should be appreciated that the functionality of the units of the user equipment may be integrated or distributed over multiple components of the user equipment. Also, some functionality may be accomplished by using further devices.

Next, the operation of the communication system 1 of FIG. 1 in accordance with an embodiment of the invention will be described in further detail.

When the user equipment 4 is switched on, the user equipment 4 and DSLAM 5 synchronize at DSL transmission level. The monitoring unit 11 senses an actual data transmission rate of the access network 2.

Then, the user equipment 4 starts a PPP session and transmits a PPP logon request to the edge router 6. The processing unit 10, as shown in FIG. 2, includes sensed actual line speed of the access network 2 in this PPP logon request. This can, e.g., be done by adding the actual line speed to the ISP alias, preceded by a unique separator. An exemplary format may, e.g., be: <username>@<ISP alias>:<line speed>.

In response to receiving the actual line speed in the PPP logon request, the edge router 6 selects an appropriate tunnel or tunes to an appropriate data transmission rate for the broadband network 3 after PPP setup. The edge router 6 forwards the PPP logon request, including the actual line speed of the access network as received from the user equipment 4, to the RADIUS server 9.

The RADIUS server 9 performs an authorization check on the logon request and forwards the line speed received with the logon request from the edge router 6 to the SP router 7 if the authorization check is passed.

As a consequence, both the edge router 6 and the SP router 7 possess information about the actual line speed of the access network 2 as sensed by a particular user equipment 4. Therefore, both broadband network devices 6, 7 are capable of selecting an appropriate tunnel. In particular, a tunnel is selected that prevents the DSLAM 5 from being a data transmission bottleneck by assigning a tunnel with a data transmission rate that is less than or equal to the line rate as monitored by the user equipment 4 for the access network 2. The PPP session is then started at an end-to-end data transmission rate corresponding to the actual transmission rate in the local loop 2.

As an alternative, the data transmission rate of the broadband network 3 may be tuned to substantially match the data transmission rate of the access network 2.

The information concerning the data transmission rate of the access network is preferably communicated to a broadband network in a point-to-point protocol (PPP) logon request. The data transmission rate information (i.e., layer 2 information) is then transferred to the PPP protocol (i.e., a layer 3 protocol). In this manner, it is not necessary to apply special procedures/communication/protocols between the DSLAM 5 and the first broadband network device 6.

Interference conditions in the access network may change during data transmission. Therefore, in an advantageous embodiment of the invention, the data transmission rate for the access network is monitored by the monitoring unit 11 at several points in time or continuously. A rate threshold may be programmed in the processing unit 10. When the data transmission rate for the access network 2 drops below this predetermined rate threshold, the user equipment 4 disconnects from the access network 2.

In particular, the user equipment 4 disconnects the point-to-point session and then re-connects by transmitting a logon request containing information concerning a data transmission rate valid for the renewed connection.

As an alternative, the user equipment 4 disconnects from the access network at a transmission level, resynchronizes and re-connects by transmitting a point-to-point protocol logon request containing information concerning a data transmission rate valid for the renewed connection.

Multiple variants of the above-described embodiment are envisaged. As an example, the PPP session may be a PPP over ATM (PPPoA) session or a PPP over Ethernet (PPPoE) session.

1. A method of selecting a data transmission rate for data transmission over at least a part of a broadband network, said broadband network being connected to an access network for providing access for user equipment to said broadband network, the method comprising the steps of:
receiving rate information from said user equipment comprising a rate for transmitting data over said access network; and
selecting a data transmission rate for transmitting data over said part of the broadband network, which is less than or substantially equal to said data transmission rate for transmitting data over said access network.

2. The method recited in claim 1 wherein the received rate information comprises information monitored by said user equipment for data transmission over said access network and said data transmission rate for said broadband network is selected in response to said information from the user equipment.

3. The method recited in claim 1 wherein the rate information is received in a point-to-point protocol logon request from said user equipment.

4. The method recited in claim 3 wherein said broadband network comprises a first broadband network device and said point-to-point protocol logon request is received by first broadband network device.

5. The method recited in claim 4 wherein said first broadband network device forwards said logon request to a RADIUS server.

6. The method recited in claim 5 wherein said RADIUS server checks authorization of the user equipment and, if said user equipment is authorized, forwards said rate information to a second broadband network device.

7. The method recited in claim 1 wherein said broadband network comprises at least a first broadband network device and a second broadband network device, said first and second broadband network devices being capable of establishing a plurality of tunnels with different data transmission rates between said first and second broadband network devices, and said method further comprises the step of selecting one of the tunnels with a data transmission rate less than or substantially equal to said data transmission rate for transmitting data over said access network.

8. The method according to claim 1 wherein said broadband network comprises at least a first broadband network device and a second broadband network device, said first and second broadband network devices being capable of establishing a connection of a tunable data transmission rate, and said method further comprises the step of tuning the data transmission rate for selecting a data transmission rate less than or substantially equal to said data transmission rate for transmitting data over said access network.

9. The method according to claim 1 wherein said rate information is received repeatedly.

10. A computer readable medium having computer execution instruction stored therein, the instruction being executed by a computer, for performing the steps of claim 1.

11. A system for selecting a data transmission rate comprising:
a broadband network comprising a first broadband network device and a second broadband network device; and
an access network arranged for connecting a user equipment to said broadband network;
wherein at least one of said first and second broadband network device are arranged for receiving rate information from said user equipment comprising a data transmission rate for transmitting data over said access network and at least one of said first and second broadband network devices are arranged for selecting a data transmission rate for transmitting data between said first and second broadband network devices, which is less than or substantially equal to said data transmission rate for transmitting data over said access network.

12. The system recited in claim 11 wherein the rate information is received in a point-to-point protocol logon request from said user equipment.

13. The system recited in claim 12 further comprising a RADIUS server for authorizing said user equipment, said RADIUS server being arranged for receiving said logon request and forwarding said rate information to said second broadband network device upon authorizing said logon request.

14. The system recited in claim 11 wherein said first and second broadband network devices are capable of establishing a plurality of tunnels with different data transmission rates between said first and second broadband network devices and wherein at least one of said first and second broadband network devices is arranged for selecting one of the tunnels with a data transmission rate less than or substantially equal to said data transmission rate for transmitting data over said access network.

15. The system according to claim 11 wherein said first and second broadband network devices are capable of establishing a connection of a tunable data transmission rate and wherein at least one of the first and second broadband network devices are arranged for tuning the data transmission rate for selecting a data transmission rate less than or substantially equal to said data transmission rate for transmitting data over said access network.

16. A user equipment connectable to an access network for providing access to a broadband network, said user equipment being configured to:
monitor a data transmission rate for data transmission over said access network; and
transmit information concerning said data transmission rate over said access network.

17. The user equipment recited in claim 16, wherein said user equipment is configured to transmit said information in a point-to-point protocol logon request.

18. The user equipment recited in claim 17 wherein said user equipment is configured to transmit said information repeatedly.

19. The user equipment recited in claim 16 wherein said user equipment is configured to compare said data transmission rate with a rate threshold during connection with said access network and to disconnect from said access network if said data transmission rate drops below said threshold.

20. The user equipment recited in claim 19 wherein said user equipment is configured to disconnect a point-to-point session and then to re-connect by transmitting a logon request containing information concerning a data transmission rate valid for said renewed connection.

21. The user equipment recited in claim 19, wherein said user equipment is configured to disconnect from said access network at a transmission level, to resynchronize and to re-connect by transmitting a point-to-point protocol logon request containing information concerning a data transmission rate valid for said renewed connection.

22. A broadband network having means for performing the method recited in claim 1.
